(19) United States
(12) Patent Application Publication
(10) Pub. No.: US 2002/0148279 A1
(43) Pub. Date: Oct. 17, 2002

(54) Gas sensor

(76) Inventors: Helmut Weyl, Schwieberdingen (DE); Juergen Werner, Leinfelden-Echterdingen (DE); Jurgen Wilde, Fellbach (DE); Andreas Werner, Korntal-Muenchingen (DE)

Correspondence Address: KENYON & KENYON, ONE BROADWAY, NEW YORK, NY, 10004, US

(21) Appl. No.: 10/030,995

(22) PCT Filed: May 8, 2001
(86) PCT No.: PCT/DE01/01735

(30) Foreign Application Priority Data
May 11, 2000 (DE) 100 22 958.1

(51) Int. Cl. G01N 9/00

(52) U.S. Cl. 73/31.05

(57) ABSTRACT

The present invention relates to a gas sensor (10) having a metallic housing (12) and being secured via a hollow screw (50) in a measuring opening (56) having a measuring gas, the housing (12) including a collar (51) as the support for the hollow screw (50). A conically shaped surface (54a), with which the gas sensor (10) rests on a conically shaped opposite surface (54b) of measuring opening (56), is provided on the side of housing (12) facing the measuring opening (56). The conically shaped surface (54a) of the housing (12) has an angle a with respect to a longitudinal axis of housing (12) that is less than 60°.

### BACKGROUND INFORMATION

The present invention starts out from a gas sensor according to the definition of the species in the main claim. Such a gas sensor is known, for example, from German Patent No. 196 48 685 A1. Such gas sensors have a metallic housing with a collar with which the gas sensor rests on an annular surface of a measuring opening provided on an exhaust pipe. The annular surface is situated so as to be perpendicular to the longitudinal axis of the gas sensor. In addition, a threaded flange into which a hollow screw is screwed is welded onto the exhaust pipe, the end face of the hollow screw pressing against the collar of the housing, thereby supporting the gas sensor in the measuring opening. Such a gas sensor can co-rotate when the hollow screw is tightened, thereby complicating assembly.

### SUMMARY OF THE INVENTION

The gas sensor according to the present invention and having the characterizing features of the main claim has the advantage that when the hollow screw is screwed in, the gas sensor is secured by self-locking. The housing of the gas sensor of the present invention has a conically shaped surface that is seated on a conically shaped opposite surface of the measuring gas opening. The conical shape achieves self-locking, so that the gas sensor is prevented from co-rotating when the hollow screw is screwed in.

Advantageous further refinements of the gas sensor according to the present invention are made possible by the measures recited in the dependent claims.

The angle of the conically shaped surface of the gas sensor housing being less than 60° with respect to the longitudinal axis of the housing results in reliable self-locking when the hollow screw is screwed in.

### BRIEF DESCRIPTION OF THE DRAWINGS

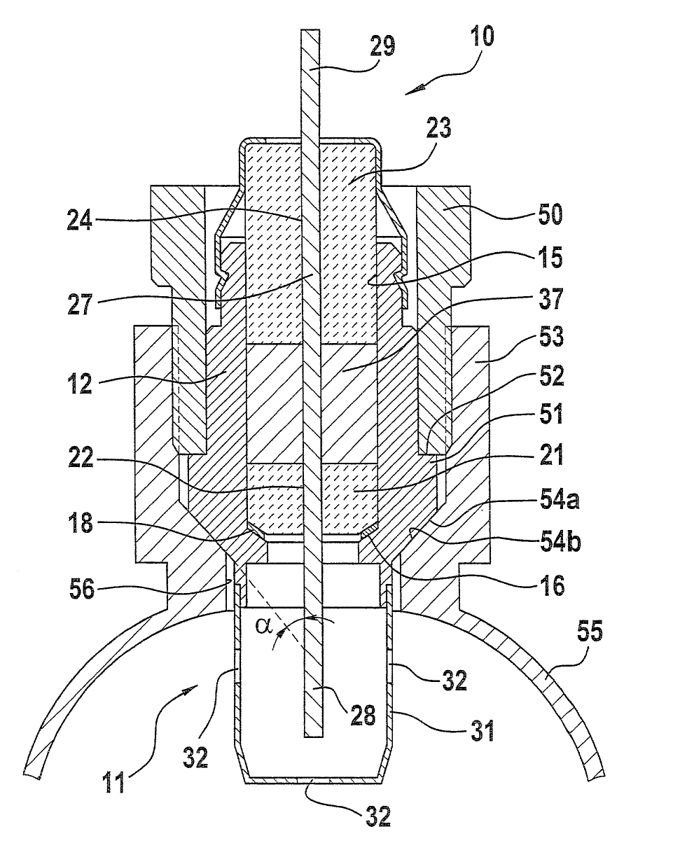

The present invention is explained in greater detail by the drawings and the subsequent description. FIG. 1 shows a sectional view of a gas sensor as well as an exhaust pipe in the region of a measuring gas opening.

### DESCRIPTION OF THE EXEMPLARY EMBODIMENT

The single figure shows a gas sensor 10, e.g. a temperature sensor, having a metallic housing 12, in which a sensor element 27 is fixed. A measuring-gas-side segment 11 of gas sensor 10 projects into a measuring opening 56 of a measuring gas chamber, e.g. an exhaust pipe 55.

Housing 12 of gas sensor 10 has a longitudinal bore hole 15 having a shoulder-shaped annular surface 16. A metallic sealing ring 18, for example, on which a molded ceramic part 21 on the measuring gas side rests, is located on shoulder-shaped annular surface 16. Molded ceramic part 21 on the measuring gas side has a continuous opening 22 on the measuring gas side, which runs in the direction of longitudinal bore hole 15. Set apart from molded ceramic part 21 on the measuring gas side, a molded ceramic part 23 on the terminal side is also situated in longitudinal bore hole 15. Molded ceramic part 23 on the terminal side also has a centrally located, continuous opening 24 on the terminal side, which runs in the direction of longitudinal bore hole 15. Measuring-gas-side opening 22 of molded ceramic part 21 on the measuring gas side and terminal-side opening 24 of molded ceramic part 23 on the terminal side run in true alignment with respect to one another. A sealing element 37 is situated between molded ceramic part 21 on the measuring gas side and molded ceramic part 23 on the terminal side. Plate-shaped sensor element 27, having an end segment 28 on the measuring gas side and an end segment 29 on the terminal side, is located in openings 22, 24. End segment 29 on the terminal side has terminal contacts (not shown in greater detail) that are contacted by a contact plug (also not shown) provided with connecting cables.

In measuring-gas-side segment 11 of gas sensor 10, measuring-gas-side end segment 28 of sensor element 27 projects from housing 12 and is surrounded by a protective pipe 31, which is affixed to housing 12. Protective pipe 31 has inlet and outlet openings 32 for the gas to be measured. Gas sensor 10 is situated in measuring opening 56 such that its segment 11 on the measuring gas side is located in exhaust pipe 55. For this purpose, measuring opening 56 of exhaust pipe 55 is surrounded by a threaded flange 53, into which a hollow screw 50 is screwed, an end face 52 of the hollow screw resting on a collar 51 provided on housing 12. A conically shaped surface 54a, which rests on a conically shaped opposite surface 54b of measuring gas opening 56, is provided on the side of housing 12 facing measuring opening 56. Conically shaped surfaces 54 of housing 12 or of measuring gas opening 56 have an angle a with respect to the direction of longitudinal bore hole 15 of housing 12, angle a being less than 60°, e.g. 45°. The self-locking when the hollow screw is screwed in is particularly reliable in the case of an angle a between 40 and 50°, preferably 45°.

Another specific embodiment of the present invention is conceivable in which hollow screw 50 is replaced by a screw cap that engages with a winding on the housing.

What is claimed is:

1. A gas sensor having a metallic housing and being secured via a fastening element in a measuring opening having a measuring gas, the housing including a collar as the support for the fastening element, wherein a conically shaped surface (54a), which rests on a conically shaped opposite surface (54b) formed at the measuring opening (56), is provided on the side of the housing (12) facing the measuring opening (56).

2. The gas sensor as recited in claim 1, wherein the conically shaped surface (54a) of the housing (12) has an angle a with respect to a longitudinal axis of the housing (12) that is less than 60°.

3. The gas sensor as recited in claim 1, wherein the fastening element is a hollow screw (50) or a screw cap.
